(19) United States
(12) Patent Application Publication
(10) Pub. No.: US 2023/0146663 A1
(43) Pub. Date: May 11, 2023

(54) CHARGING STAND FOR ELECTRONIC EQUIPMENT

(71) Applicant: Shanghai EdgelnterLink Technology Co., Ltd., Shanghai (CN)

(72) Inventor: YUEWU ZHAO, Shanghai (CN)

(21) Appl. No.: 17/976,873

(22) Filed: Oct. 31, 2022

(30) Foreign Application Priority Data
Nov. 5, 2021 (CN) 2021226940201
Mar. 14, 2022 (CN) 202220551161X
Mar. 14, 2022 (CN) 202220552567X
Sep. 6, 2022 (CN) 2022223616520

(51) Int. Cl. H02J 7/00

(52) U.S. Cl. CPC H02J 7/0042; H02J 7/00032; H04B 5/0025

(57) ABSTRACT

The present disclosure relates to a charging stand for electronic equipment. The charging stand for electronic equipment includes a protection shell, an adjustable stand, and a base. One end of the adjustable stand is detachably electrically connected to the protection shell, and the other end is connected to the base. A typer-c interface connected to a charging jack of electronic equipment is arranged in the protection shell; and the typer-c interface is connected to an internal circuit of the base through a circuit inside the adjustable stand.

### CROSS-REFERENCE TO RELATED APPLICATIONS

The application claims priority of Chinese patent application 202122694020.1, filed on Nov. 5, 2021, priority of Chinese patent application 202220552567X, filed on Mar. 15, 2022, priority of Chinese patent application 202220551161X, filed on Mar. 15, 2022, and priority of Chinese patent application 2022223616520, filed on Sep. 6, 2022, which are incorporated herein by reference in its entireties.

### TECHNICAL FIELD

The present disclosure relates to the technical field of electronic equipment aid equipment, in particular, to a charging stand for electronic equipment.

### BACKGROUND

The service industry mainly includes service staff and consumers. Nowadays, with the well development of science and technology, electronic products have been applied to the service industry due to their increasingly powerful functions. An intelligent calling system is formed between the service staff and the customers nowadays using tablet computers in the service industry. A tablet computer will consume electricity when they are in use, and timely charging is necessary. A charging data wire for charging cannot meet the requirement. Meanwhile, a data wire or joint may fail or be in poor contact since it is required to be plugged for charging, resulting in a charging failure. In another aspect, it is inconvenient to place a tablet computer on an existing charging seat since the tablet computer is easy to topple and fall and damaged. Moreover, tablet computer equipment does not have a card reading function since it usually does not have an NFC chip, which brings a great convenience for services.

In addition, current electronic equipment, such as a tablet computer, is generally directly connected to a power supply for charging through a data wire or a charger head. However, this causes messy data wires. Particularly, when there are many desktop devices, multiple data wires are twined together. At the same time, the electronic equipment is also easily damaged since it is placed randomly.

### SUMMARY

In order to overcome the shortcomings in the prior art, the present disclosure provides charging stand for electronic equipment including a protection shell, an adjustable stand, and a base, wherein one end of the adjustable stand is detachably electrically connected to the protection shell, and the other end is connected to the base; a typer-c interface connected to a charging jack of electronic equipment is arranged in the protection shell; and the typer-c interface is connected to an internal circuit of the base through a circuit inside the adjustable stand.

Further, a groove is formed in the protection shell; the adjustable stand includes a bulge, a turntable, a connection buckle, a telescopic rod, and a connection seat; one end of the telescopic rod is fixedly connected to the connection seat, and the other end is fixedly connected to the connection buckle; the other end of the connection buckle is hinged with the turntable; the other surface of the turntable is connected with the bulge; and the bulge is clamped in the groove when the adjustable stand is connected with the protection shell.

Further, the bulge and the groove are connected in a magnetic attraction manner; and the bulge and the turntable are rotatably connected.

Further, a bottom of the groove is provided with a metal contact hole; the metal contact hole is electrically connected with the typer-c interface in the protection shell; a metal contact point matched with the metal contact hole is arranged on the bulge; the metal contact point is electrically connected to the circuit inside the adjustable stand; the metal contact point is inserted into the metal contact hole when the bulge is clamped in the groove; and the metal contact point and the metal contact hole are pogo pin connectors.

Further, a mounting gap is formed in an edge of the base; the connection seat is mounted in the mounting gap; and the mounting gap and the connection seat are connected in a magnetic attraction manner.

Further, the charging stand for electronic equipment includes a docking station, the docking station is connected to the internal circuit of the base through a lead wire to provide electric energy to the entire charging stand for electronic equipment; and a plurality of interfaces used for data transmission are further arranged on the docking station.

Further, the charging stand for electronic equipment includes a built-in NFC chip, a groove space is arranged inside the protection shell; the NFC chip is mounted in the groove space; the typer-c interface is further arranged in the protection shell; the typer-c interface is connected to the NFC chip through a circuit; one end of the adjustable stand is detachably connected to the protection shell, and the other end is connected to the base; and the typer-c interface is connected to an internal circuit of the base through a circuit inside the adjustable stand.

Further, an NFC sign is arranged at a position, corresponding to the NFC chip, on the protection shell; and a camera opening is further arranged on the protection shell.

Further, the protection shell with the built-in NFC chip further includes a docking station; the docking station is connected to the internal circuit of the base through a lead wire; the docking station is connected to an external power supply to provide electric energy to the entire protection shell with the built-in NFC chip; and a plurality of interfaces used for data transmission are further arranged on the docking station.

Further, a groove is arranged in the protection shell; the adjustable stand includes a bulge, a turntable, a connection buckle, a telescopic rod, and a connection seat; one end of the telescopic rod is fixedly connected to the connection seat, and the other end is fixedly connected to the connection buckle; the other end of the connection buckle is hinged with the turntable; the other surface of the turntable is rotatably connected with the bulge; and the bulge is clamped in the groove when the adjustable stand is connected with the protection shell.

Further, a bottom of the groove is provided with a metal contact hole; the metal contact hole is electrically connected with the typer-c interface in the protection shell; a metal contact point matched with the metal contact hole is arranged on the bulge; the metal contact point is electrically connected to the circuit inside the adjustable stand; the metal contact point is inserted into the metal contact hole when the bulge is clamped in the groove; and the metal contact point and the metal contact hole are pogo pin connectors.

Further, a mounting gap is formed in an edge of the base; the connection seat is mounted in the mounting gap; and the mounting gap and the connection seat are connected in a magnetic attraction manner.

The present disclosure also provides a charging stand for electronic equipment including a shell body used for fixing electronic equipment, wherein the shell body is detachably connected with a back splint; the back splint is connected with a telescopic rod; a bottom of the telescopic rod is fixed to a base; a positioning slot is formed in a side surface of the shell body facing the back splint; a metal plate is arranged in the positioning slot; a side edge of the shell body is provided with a Type-C interface connected to a charging jack of the electronic equipment; a lead wire for connecting the metal plate with the Type-C interface is arranged in the shell body; a side surface of the back splint facing the shell body is provided with a bulge portion matched with the positioning slot; a pogo pin metal ejection contact point and a first magnetic member are arranged on the bulge portion; the base is provided with a Type-C power line; the Type-C power line and the pogo pin metal ejection contact point are communicated through a lead wire; and the lead wire is arranged in the base, the telescopic rod and the back splint.

Further, a side surface of the shell body facing the back splint is provided with an NFC module accommodating slot; an avoiding hole used for avoiding a component of the electronic equipment is formed in the shell body in a manner of running through the shell body in a thickness direction; the metal plate is arranged in a center of the positioning slot, and a second magnetic member magnetically attracting the first magnetic member is further arranged around a circumferential direction of the metal plate; a thickness of the second magnetic member is not less than that of the metal plate; and one side of the base is provided with an external connection magnetic member used for magnetically attracting external equipment.

Further, a bottom surface of the base is provided with a T-shaped avoiding slot; the T-shaped avoiding slot is communicated with three side edges of the base; and an elastic buckle used for buckling the Type-C power line is arranged in the T-shaped avoiding slot.

The present disclosure also provides a charging stand for electronic equipment including a charging device main body, wherein the charging device main body includes a base, a rotating module, a stand, and a connection portion used for connecting the base with the stand; the rotating module is arranged on the stand; a mounting region used for providing a mounting space for the connection portion is arranged on the base; the connection portion includes a fixed member and a mounting socket arranged on the fixed member; a fastener is arranged on the fixed member; a fastening slot matched with the fastener is arranged on the base; the mounting socket is detachably connected with the stand; the fixed member is detachably connected into the mounting region; a sliding alignment assembly is arranged between the mounting region and the fixed member; the sliding alignment assembly includes a sliding chute and a sliding plate matched with the sliding chute; the sliding chute is formed inside the mounting region; and the sliding plate is arranged along a side edge of the fixed member.

Further, the rotating module includes a turning assembly, a rotating assembly, a limiting member arranged on the turning assembly, and an interface assembly arranged on the rotating assembly; the turning assembly is movably connected with the stand; and the rotating assembly is detachably connected with the turning assembly.

Further, the stand includes a first frame bar, a second frame bar, and a damping member; the first frame bar is connected with the second frame bar through a damping member; the mounting socket is detachably connected to the first frame bar; and the turning assembly is movably connected to the second frame bar; the base includes a first assembly part and a second assembly part; the first assembly part is provided with a wire duct along a side edge; and a wire outlet matched with the wire duct is further formed in the first assembly part.

Further, the turning assembly includes a mounting disk used for connecting the rotating assembly, a mounting table, a turning member, a rotating pin used for connecting the turning member, and a fixing table used for fixing the rotating pin; the mounting table is fixedly connected with the second frame bar; the fixing table is fixedly mounted on the mounting table; the turning member is movably connected to the fixing table through the rotating pin; the turning member is fixedly connected to the mounting disk; and the turning pin is used as a rotating shaft of the turning member to rotate the turning member after the turning member is stressed; the rotating assembly includes a rotating disk, a limiting disk, a magnetic attraction disk arranged on the rotating disk, and a spinning disk; the rotating disk is connected to the spinning disk; the spinning disk is movably connected to the turning assembly; the limiting disk is rotatably connected to the spinning disk; the spinning disk drives the limiting disk to rotate under the action of an axial force; the rotating disk rotates with the rotation of the spinning disk; the limiting member is matched with the limiting disk; the limiting member is used for limiting a rotation range of the limiting disk; the interface assembly includes a 6PIN connector and a fixing plate used for fixing the 6PIN connector; the fixing plate is arranged on the limiting disk; through slots are formed in the magnetic attraction disk and the rotating disk; the 6PIN connector is fixed inside the fixing plate; and a spring needle of the 6PIN connector passes through the through slots and extends out of the magnetic attraction disk.

Further, the base is provided with a magnetic attraction member along a side edge of the base; and a plurality of charging device main bodies are combined through the magnetic attraction members.

The present disclosure has the beneficial effects: the charging stand for electronic equipment solves the problem that the traditional electronic equipment charging needs to plug and remove data wires, The tablet device is charged by means of the detachable electric connection between the adjustable stand and the protection shell body, so as to prevent the problem of a charging failure caused by a fact that the data wire or joint fails or is in poor contact. Meanwhile, the conventional situation that the protection shell only plays a role of protecting the tablet device is changed, so that the protection shell can protect and charge the tablet device 6, which achieves multifunctionality of a protection shell.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a three-dimensional diagram of a charging stand for electronic equipment according to Embodiment I;

FIG. 2 is a front view of a charging stand for electronic equipment according to Embodiment I;

FIG. 3 is a side view of a charging stand for electronic equipment according to Embodiment I;

FIG. 4 is a bottom view of a charging stand for electronic equipment according to Embodiment I;

FIG. 5 is a sectional view of a protection shell with a built-in NFC chip according to Embodiment II;

FIG. 6 is a structural diagram of a protection shell with a built-in NFC chip according to Embodiment II;

FIG. 7 is a structural diagram of a protection shell with a built-in NFC chip and a charging stand for electronic equipment according to Embodiment II;

FIG. 8 is a structural diagram from another viewing angle of a protection shell with a built-in NFC chip and a charging stand for electronic equipment according to Embodiment II;

FIG. 9 is a structural diagram of an adjustable stand of a protection shell with a built-in NFC chip and a charging stand for electronic equipment according to Embodiment II;

FIG. 10 is a schematic structural diagram of another viewing angle of an adjustable stand of a protection shell with a built-in NFC chip and a charging stand for electronic equipment according to Embodiment II;

FIG. 11 is a schematic structural diagram of a base of a protection shell with a built-in NFC chip and a charging stand for electronic equipment according to Embodiment II;

FIG. 12 is a structural diagram of a charging stand for electronic equipment according to Embodiment III;

FIG. 13 is a schematic diagram of cooperation between a base and a connection portion according to Embodiment III;

FIG. 14 is an exploded diagram of a base and a connection portion according to Embodiment III;

FIG. 15 is an exploded diagram of a rotating module according to Embodiment III;

FIG. 16 is an exploded diagram of a rotating assembly according to Embodiment III;

FIG. 17 is a schematic diagram of a mechanism after two charging device main bodies magnetically attract each other according to Embodiment III;

FIG. 18 is a schematic diagram of cooperation between a magnetic attraction member and a base according to Embodiment III; and

FIG. 19 is a bottom view after two bases magnetically attract each other according to Embodiment III.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the application, “a plurality of” means two or more, unless otherwise specifically defined.

### Embodiment I

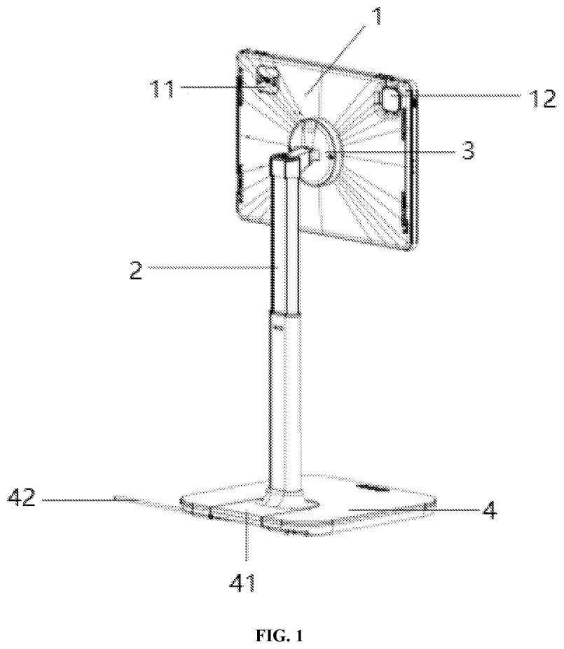

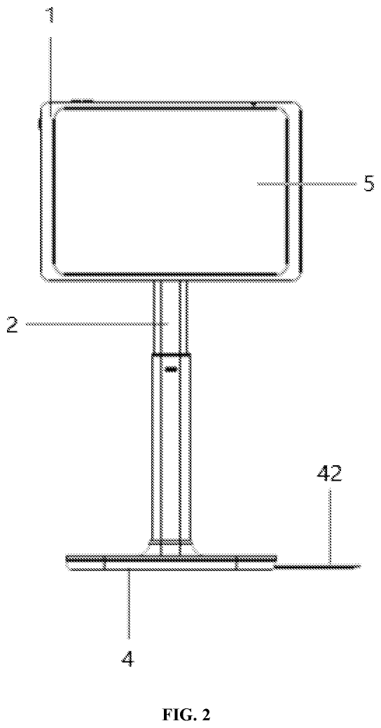

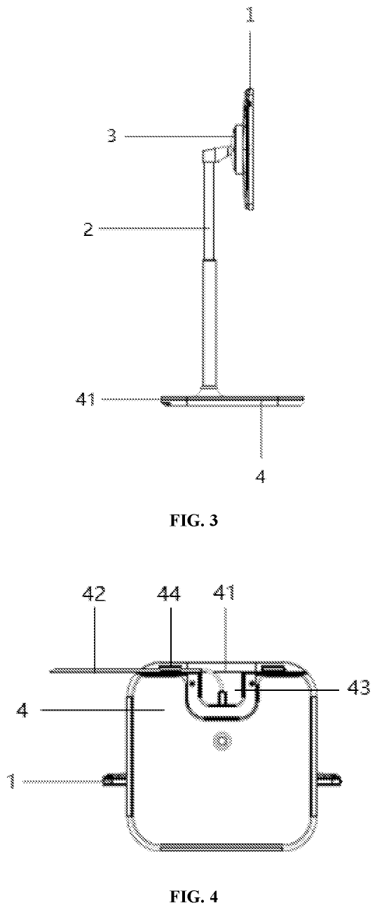

As shown in FIG. 1 to FIG. 3, a charging stand for electronic equipment includes a shell body 1, a back splint 3, a telescopic rod 2, and a base 4. The shell body 1 is used for fixing electronic equipment. The way to fix the electronic equipment by the shell body 1 may be, but not limited to, magnetic attraction, pasting and fastening. The shell body 1 is detachably connected with the back splint 3. A positioning slot is formed in a side surface of the shell body 1 facing the back splint 3. A metal plate is arranged in the positioning slot. A side surface of the back splint 3 facing the shell body 1 is provided with a bulge portion matched with the positioning slot. The bulge portion is provided with a first magnetic member. The shell body 1 and the back splint 3 are detachably connected through the magnetic attraction between the first magnetic member and the metal plate. A section of the positioning slot parallel to a bottom surface of the positioning slot may be polygonal. In this embodiment, the positioning slot is a rectangular slot. The bulge portion is in a corresponding shape, thus enhancing the positioning effect. Meanwhile, a side edge of the shell body 1 is provided with a Type-C interface used connected to a charging jack of the electronic equipment. A lead wire for connecting the metal plate with the Type-C interface is arranged in the shell body 1, so that the electronic equipment is charged through the Type-C interface. Correspondingly, a pogo pin metal ejection contact point is arranged on the bulge portion. After the shell body 1 and the back splint 3 are connected, full and stable contact between the metal plate and the pogo pin metal ejection contact is achieved through magnetic attraction. The metal plate is arranged in a center of the positioning slot. Furthermore, a second magnetic member used for magnetically attracting the first magnetic member is also arranged around a circumferential direction of the metal plate, so that the metal plate for electricity conduction is as small as possible to improve the charging efficiency. Furthermore, a thickness of the second magnetic member is not less than that of the metal plate, so that it is ensured that magnetic attraction is achieved. The electronic equipment is a tablet computer

The back splint 3 is connected with the telescopic rod 2. The back splint 3 can be fixedly or rotatably connected with the telescopic rod 2, and rotatable connection is preferred. Thus, it is convenient to place the electronic equipment on the shell body 1 and to adjust an angle of the electronic equipment for use during charging.

A bottom of the telescopic rod 2 is fixed to the base 4, and the base 4 is provided with a Type-C power line 42. The Type-C power line 42 is connected to an external power supply. The Type-C power line 42 and the pogo pin metal ejection contact are communicated through a lead wire. The lead wire is arranged in the base 4, the telescopic rod 2 and the back splint 3, so as to finally charge the electronic equipment through the Type-C interface on the shell body 1 and avoid a disorder of external data wires. Preferably, one side of the base 4 is provided with an external connection magnetic member 41 used for magnetically attracting external equipment. For example, the external connection magnetic member is connected to another charging stand for electronic equipment back to back, so as to fix the two devices into a whole and improve the stability of the charging stand for electronic equipment.

An NFC module accommodating module 11 is formed in a side surface of the shell body 1 facing the back splint 3 and is used for placing an NFC module. The slotting position realizes that the NFC module can be placed without taking down the electronic equipment. The use is convenient.

An avoiding hole 12 used for avoiding a component of the electronic equipment is formed in the shell body 1 in a manner of running through the shell body in a thickness direction. For example, in this embodiment, the electronic equipment is iPad5. The avoiding hole 12 is formed in a position, corresponding to a camera of the iPad5, of the shell body 1.

As shown in FIG. 4, a T-shaped avoiding slot 43 is formed in a bottom surface of the base 4, and the T-shaped avoiding slot 43 is communicated with three side edges of the base 4, so that the Type-C power line 42 can be arranged along an edge of the base 4 as much as possible, and it is convenient to arrange the external connection magnetic member 41 such two charging stand for electronic equipments are fixed back to back. An elastic buckle 44 used for buckling the Type-C power line 42 is arranged in the T-shaped avoiding slot 43, thus limiting the position of the Type-C power line 42.

According to the charging stand for electronic equipment of this embodiment, the electronic equipment is fixed through the shell body, and the shell body cooperates with the back splint, the telescopic rod and the base to turn on a power supply. which finally charges the electronic equipment through the Type-C interface on the shell body, thus avoiding a disorder of the data wires. Furthermore, the electronic equipment is fixed one by one during charging to avoid a disorder of placement.

### Embodiment II

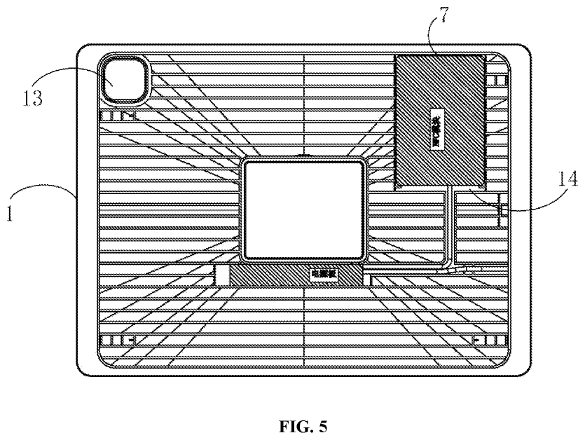

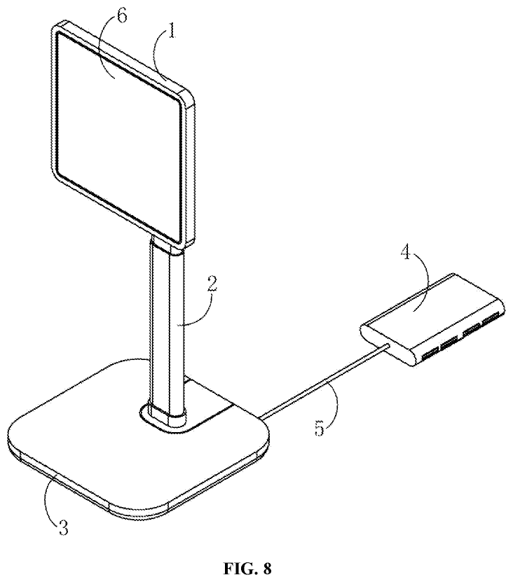

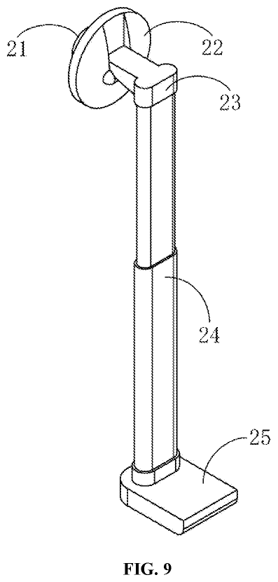

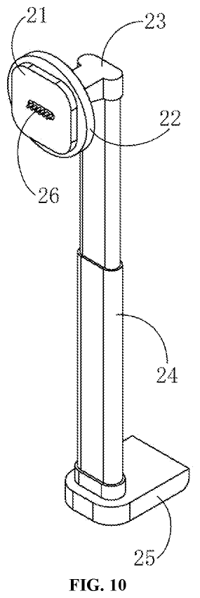

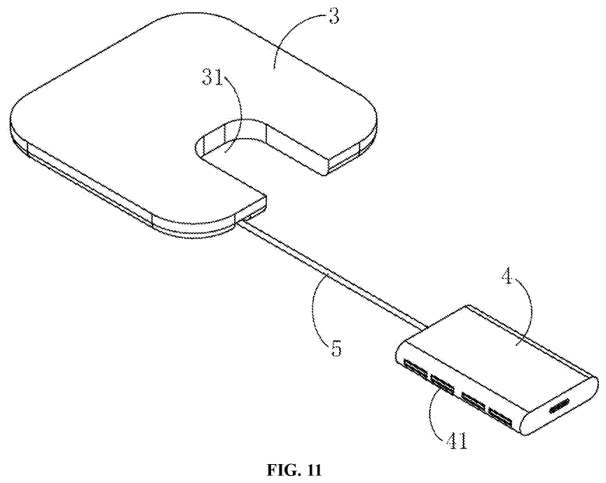

As shown in FIG. 5 to FIG. 11, this embodiment provides a charging stand for electronic equipment, including a protection shell 1, an adjustable stand 2, a base 3, and a docking station 4. One end of the adjustable stand 2 is detachably electrically connected with the protection shell 1, and the other end is connected with the base 3. The docking station 4 is connected to an internal circuit of the base 3 through a lead wire 5. A typer-c interface (not shown in the figure) connected to a charging jack of a tablet device 6 is arranged in the protection shell 1. The typer-c interface is connected with the internal circuit of the base 3 through a circuit inside the adjustable stand 2. The docking station 4 is connected to an external power supply to supply electric energy to the entire charging stand for electronic equipment.

The tablet device 6 is mounted in the protection shell 1. The protection shell 1 protects the tablet device 6. Meanwhile, the charging jack of the tablet device 6 is connected to the typer-c interface in the protection shell 1. The docking station 4 is connected to the external power supply to charge the tablet device 6.

According to the charging stand for electronic equipment of this embodiment, the problem that plugging a data wire is required during charging of a traditional tablet device is changed. The tablet device 6 is charged by means of the detachable electric connection between the adjustable stand 2 and the protection shell 1, so as to prevent the problem of a charging failure caused by a fact that the data wire or joint fails or is in poor contact. Meanwhile, the conventional situation that the protection shell 1 only plays a role of protecting the tablet device 6 is changed, so that the protection shell can protect and charge the tablet device 6, which achieves multifunctionality of a protection shell.

A bottom of a groove 11 is provided with a metal contact hole 12. The metal contact hole 12 is electrically connected to the typer-c interface in the protection shell 1. The protection shell 1 is provided with an accommodating cavity between the metal contact hole 12 and the typer-c interface. A conductor wire for connecting the metal contact hole 12 with the typer-c interface is placed in the accommodating cavity. A metal contact point 26 matched with the metal contact hole 12 is arranged on a bulge 21. The metal contact point 26 is electrically connected to a circuit inside the adjustable stand 2. The metal contact point 26 is inserted into the metal contact hole 12 when the bulge 21 is clamped in the groove 11. The metal contact point 26 and the metal contact hole 12 form a pogo pin connector. A plurality of interfaces 41 used for data transmission are arranged on the docking station 4.

Due to the design of the pogo pin connector, the tablet device 6 is charged by the contact between two metal contact points, thus preventing a charging failure caused by a fact that the data wire or joint fails or is in poor contact; and the process of manually plugging and unplugging the data wire is eliminated, so that the labor intensity is reduced, and the charging efficiency is improved.

The pogo pin connector at least includes a charging contact point and a communication contact point. The docking station 4 at least includes an interface 41 for an external power supply and an interface 41 for external networking communication. The charging contact point is connected with the interface for an external power supply, and the communication contact point is connected with the interface for external networking communication through a connection wire.

An edge of the base 3 is provided with a mounting gap 31, and a connection seat 25 is mounted in the mounting gap 31. The mounting gap 31 and the connection seat 25 are connected in a manner of magnetic attraction. By means of the magnetic attraction connection, it is convenient for mounting and removal.

As a preferable manner of the charging stand for electronic equipment, the protection shell 1 is further provided with an NFC chip 7. The NFC chip 7 is used for providing an approaching communication function, and various smart cards can be read. After the NFC chip 7 reads a smart card, data can be transmitted to software of the tablet device 6 through a line. The NFC chip 7 obtains electricity from the tablet device 6 through a line on the chip. Power can be supplied to the NFC chip 7 as long as the tablet device 6 supports a reverse power supply function, so as to ensure normal use of the chip.

an NFC sign 15 is arranged at a position, corresponding to the NFC chip 7, on the protection shell 1 to guide a user to swipe a card. In addition, a camera opening 13 is formed in the protection shell 1. The tablet device 6 can capture images and videos through the camera opening 13.

The charging stand for electronic equipment of this embodiment has the advantages:

1. According to the charging stand for electronic equipment of this embodiment, the problem that plugging a data wire is required during charging of a traditional tablet device is changed. The tablet device is charged through the contact between two metal contact points to prevent a charging failure caused by a fact that the data wire or joint fails or is in poor contact; and the process of manually plugging and unplugging the data wire is eliminated, so that the labor intensity is reduced, and the charging efficiency is improved. Meanwhile, the conventional situation that the protection shell only plays a role of protecting the tablet device is changed, so that the protection shell can protect and charge the tablet device, which achieves multifunctionality of the protection shell. The charging stand for electronic equipment has simple overall structure, accurate charging and high efficiency and is easy to achieve.

2. The charging stand for electronic equipment of this embodiment has a better use scenario due to the design of the adjustable stand. Furthermore, the connection wire is mostly routed inside the component to ensure the attractive appearance and also avoid the connection wire from being damaged, thus ensuring a tablet device charging success.

3. According to the charging stand for electronic equipment of this embodiment, the connection wire is connected to the docking station, and the docking station is connected with the power supply, thus achieving charging of the tablet device. The docking station has a plurality of external ports, so that it can be connected to communication equipment such as a network cable or a printer to achieve receipt printing or external communication. Meanwhile, there are two types of metal contact points on the protection shell, so that the charging device achieves communication on the basis of charging, and the experience of a user is enhanced. The charging device is also conveniently applied to industries of catering, retail, education training, medical care, electronics, and manufacturing, and improves the convenience.

4. According to the charging stand for electronic equipment of this embodiment, the metal contact point and the metal contact hole are pogo pin connectors, so that the contact is firmer. The bulge and the groove are connected in the manner of magnetic attraction. By means of the magnetic attraction connection, the protection shell can be stably placed on the adjustable stand to ensure successful charging. Furthermore, magnets on the protection shell are symmetrically arranged on two sides of the pogo pin connector, so that the protection shell can be placed on the adjustable stand more stably while ensuring the charging, and the poor contact caused by the movement of the protection shell is avoided.

5. According to the charging stand for electronic equipment of this embodiment, the conductor wires are all arranged inside the device, so that the conductor wires are prevented from being exposed outside to be easily damaged, interfered and disordered, which ensures overall tidiness and prolongs the service life of the conductor wires. Moreover, the protection shell can achieve a good buffering effect on the tablet device, avoid the tablet device from being damaged by a stress and prolong the service life of the tablet device.

As shown in FIG. 5 to FIG. 11, this embodiment further provides a protection shell with a built-in NFC chip. The protection shell with the built-in NFC chip of this embodiment includes a protection shell 1 and an NFC chip 7. Similarly, the tablet device 6 is mounted in the protection shell 1. The protection shell 1 protects the tablet device 6. The protection shell 1 is used for avoiding the tablet device 6 from being collided and falling to be damaged, so that the protection shell body is anti-collision and anti-falling. Meanwhile, a charging jack of the tablet device 6 is connected to the typer-c interface in the protection shell 1. The NFC chip 7 wrapped around by the protection shell 1 provides an approaching communication function, and various smart cards can be read. After the NFC chip 7 reads a smart card, data can be transmitted to software of the tablet device 6 through a line. The NFC chip 7 obtains electricity from the tablet device 6 through a line on the chip. Power can be supplied to the NFC chip 7 as long as the tablet device 6 supports a reverse power supply function, so as to ensure normal use of the chip.

The protection shell with the built-in NFC chip of this embodiment has a simple structure, can provide a card reading function while protecting the tablet device 6, and can transmit data through the internal line instead of Bluetooth, thus ensuring the stability of data transmission. In addition, the NFC chip 7 is not powered by a cell. The NFC chip 7 can work normally as long as the tablet device 6 has power.

An NFC sign 15 is arranged at a position, corresponding to the NFC chip 7, on the protection shell 1 to guide a user to swipe a card. In addition, a camera opening 13 is formed in the protection shell 1. The tablet device 6 can capture images and videos through the camera opening 13.

The protection shell with the built-in NFC chip of this embodiment further includes an adjustable stand 2, a base 3, and a docking station 4. One end of the adjustable stand 2 is detachably connected with the protection shell 1, and the other end is connected with the base 3. The docking station 4 is connected to an internal circuit of the base 3 through a lead wire 5. A typer-c interface is connected to the internal circuit of the base 3 through a circuit inside the adjustable stand 2. The docking station 4 is connected to an external power supply to supply electric energy to the entire protection shell with the built-in NFC chip.

When the tablet device 6 mounted in the protection shell 1 has no power, the docking station 4 is connected to the external power supply to charge the tablet device 6.

According to the protection shell with the built-in NFC chip of this embodiment, the problem that plugging a data wire is required during charging of a traditional tablet device is changed. The tablet device 6 is charged by means of the connection between the adjustable stand 2 and the protection shell 1, so as to prevent the problem of a charging failure caused by a fact that the data wire or joint fails or is in poor contact. Meanwhile, the conventional situation that the protection shell 1 only plays a role of protecting the tablet device 6 is changed, so that the protection shell can protect and charge the tablet device 6, which achieves multifunctionality of a protection shell.

A groove 11 is arranged on the protection shell 1. The adjustable stand 2 includes a bulge 21, a turntable 22, a connection buckle 23, a telescopic rod 24, and a connection seat 25. One end of the telescopic rod 24 is fixedly connected with the connection seat 25, and the other end is fixedly connected with the connection buckle 23. The other end of the connection buckle 23 is hinged with the turntable 22. The other surface of the turntable 22 is connected with the bulge 21. The bulge 21 is clamped in the groove 11 when the adjustable stand 2 is connected with the protection shell 1.

The bulge 21 and the groove 11 are connected in a manner of magnetic attraction. By means of the magnetic attraction connection, it is convenient for removal and mounting. Meanwhile, the telescopic rod 24 can be adjusted according to a required height, so that it is convenient to use. In addition, the bulge 21 and the turntable 22 are rotatably connected. The hinge between the connection buckle 23 and the turntable 22 makes it possible to adjust the protection shell 1 in different angles according to a requirement, so that it is convenient to use the tablet device 6.

A bottom of the groove 11 is provided with a metal contact hole 12. The metal contact hole 12 is electrically connected to the typer-c interface in the protection shell 1. The protection shell 1 is provided with an accommodating cavity between the metal contact hole 12 and the typer-c interface. A conductor wire for connecting the metal contact hole 12 with the typer-c interface is placed in the accommodating cavity. A metal contact point 26 matched with the metal contact hole 12 is arranged on a bulge 21. The metal contact point 26 is electrically connected to a circuit inside the adjustable stand 2. The metal contact point 26 is inserted into the metal contact hole 12 when the bulge 21 is clamped in the groove 11. The metal contact point 26 and the metal contact hole 12 form a pogo pin connector. A plurality of interfaces 41 used for data transmission are arranged on the docking station 4.

Due to the design of the pogo pin connector, the tablet device 6 is charged by the contact between two metal contact points, thus preventing a charging failure caused by a fact that the data wire or joint fails or is in poor contact; and the process of manually plugging and unplugging the data wire is eliminated, so that the labor intensity is reduced, and the charging efficiency is improved.

The pogo pin connector at least includes a charging contact point and a communication contact point. The docking station 4 at least includes an interface 41 for an external power supply and an interface 41 for external networking communication. The charging contact point is connected with the interface for an external power supply, and the communication contact point is connected with the interface for external networking communication through a connection wire.

An edge of the base 3 is provided with a mounting gap 31, and a connection seat 25 is mounted in the mounting gap 31. The mounting gap 31 and the connection seat 25 are connected in a manner of magnetic attraction. By means of the magnetic attraction connection, it is convenient for mounting and removal.

The protection shell with the built-in NFC chip of this embodiment has the advantages that the protection shell with the built-in NFC chip of this embodiment has a simple structure, can provide a card reading function while protecting the tablet device, and can transmit data through the internal line instead of Bluetooth, thus ensuring the stability of data transmission. In addition, the NFC chip is not powered by a cell. The NFC chip can work normally as long as the tablet device has power.

### Embodiment III

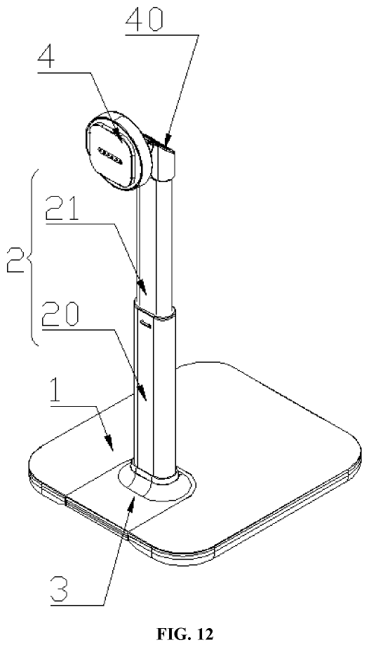

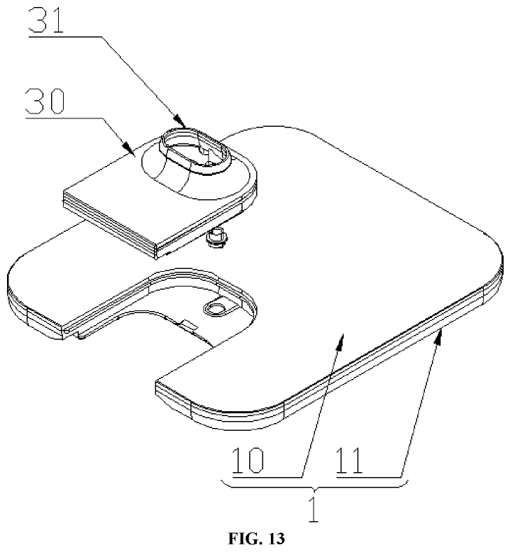

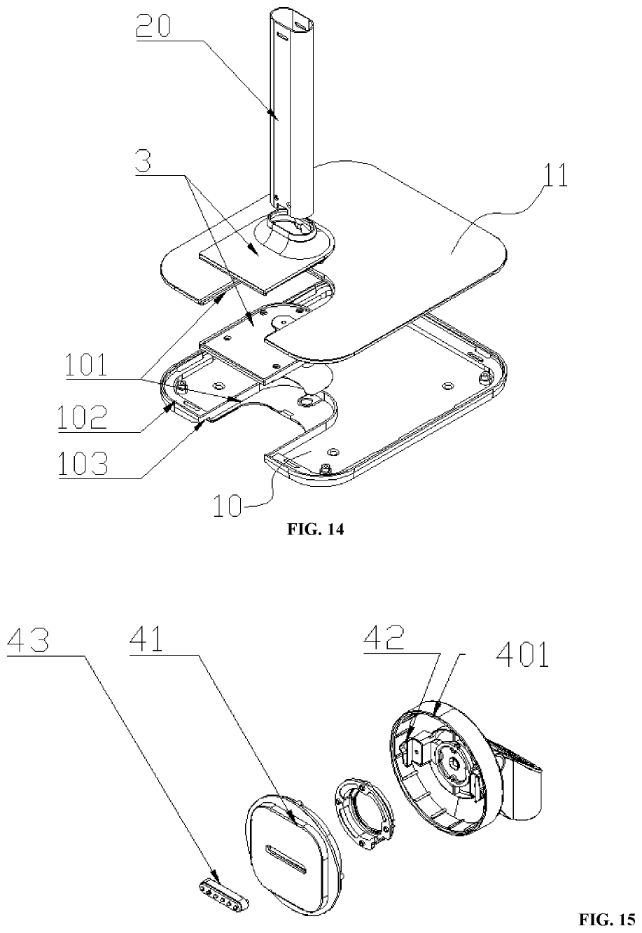

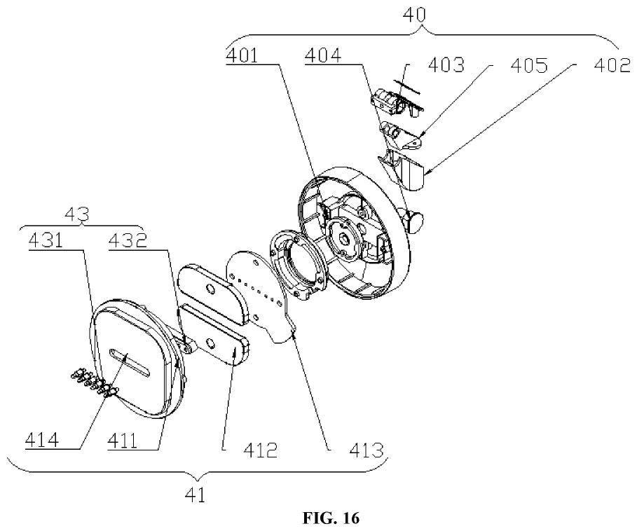

Referring to FIG. 12 to FIG. 19, this embodiment provides a charging stand for electronic equipment. According to a first aspect of this embodiment, a charging stand for electronic equipment is provided, including a charging device main body. The charging device main body includes a base 1, a rotating module 4, a stand 2, and a connection portion 3 used for connecting the base 1 with the stand 2. The rotating module 4 is arranged on the stand 2. The electronic equipment is a tablet computer.

A mounting region 101 used for providing a mounting space for the connection portion 3 is arranged on the base 1. The connection portion 3 includes a fixed member 30 and a mounting socket 31 arranged on the fixed member 30. A fastener is arranged on the fixed member 30. A fastening slot matched with the fastener is arranged on the base 1. The mounting socket 31 is detachably connected with the stand 2. The fixed member 30 is detachably connected into the mounting region 101.

A sliding alignment assembly is arranged between the mounting region 101 and the fixed member 30. The sliding alignment assembly includes a sliding chute and a sliding plate matched with the sliding chute. The sliding chute is formed inside the mounting region 101. The sliding plate is arranged along a side edge of the fixed member 30. Due to the cooperation between the sliding plate and the sliding chute, the fixed member 30 can be quickly aligned with the mounting region 101. Furthermore, the fixed member 30 can be mounted in the mounting region 101.

The rotating module 4 includes a turning assembly 40, a rotating assembly 41, a limiting member 42 arranged on the turning assembly 40, and an interface assembly 43 arranged on the rotating assembly 41. The turning assembly 40 is movably connected with the stand 2. The rotating assembly 41 is detachably connected with the turning assembly 40. The interface assembly 43 can achieve wireless charging of a tablet computer.

The stand 2 includes a first frame bar 20, a second frame bar 21, and a damping member. The first frame bar 20 is connected with the second frame bar 21 through a damping member. The mounting socket 31 is detachably connected to the first frame bar 20. The turning assembly 40 is movably connected to the second frame bar 21. The damping member can increase a friction force between the first frame bar 20 and the second frame bar 21, so that the first frame bar 20 is in close contact with the second frame bar 21, and relative movement between the two frame bars occurring without a force or under a small force is avoided.

The base 1 includes a first assembly part 10 and a second assembly part 11. The first assembly part 10 is provided with a wire duct 102 along a side edge. A wire outlet 103 matched with the wire duct 102 is further formed in the first assembly part 10. By means of the wire duct 102, it is convenient for a user to store and arrange wires used by equipment, and the wire outlet 103 can limit outgoing and incoming directions of the wires.

The turning assembly 40 includes a mounting disk 401 used for connecting the rotating assembly 41, a mounting table 402, a turning member 403, a rotating pin 404 used for connecting the turning member 403, and a fixing table 405 used for fixing the rotating pin 404. The mounting table 402 is fixedly connected with the second frame bar 21. The fixing table 405 is fixedly mounted on the mounting table 402. The turning member 403 is movably connected to the fixing table 405 through the rotating pin 404. The turning member 403 is fixedly connected to the mounting disk 401. The turning pin 404 is used as a rotating shaft of the turning member 403 to rotate the turning member 403 after the turning member is stressed.

The rotating assembly 41 includes a rotating disk 411, a limiting disk 413, a magnetic attraction disk 414 arranged on the rotating disk 411, and a spinning disk 412.

The rotating disk 411 is connected to the spinning disk 412. The spinning disk 412 is movably connected to the turning assembly 40. The limiting disk 413 is rotatably connected to the spinning disk 411. The spinning disk 412 drives the limiting disk 413 to rotate under the action of an axial force. The rotating disk 411 rotates with the rotation of the spinning disk 412. The limiting member 42 is matched with the limiting disk 413. The limiting member 42 is used for limiting a rotation range of the limiting disk 413.

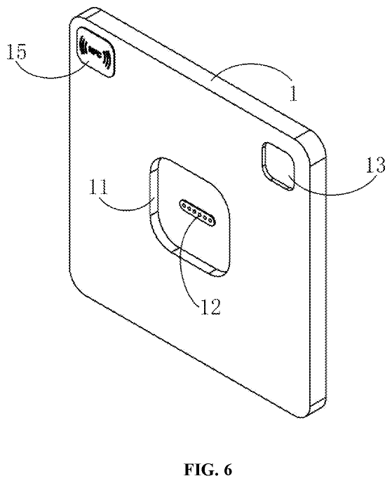

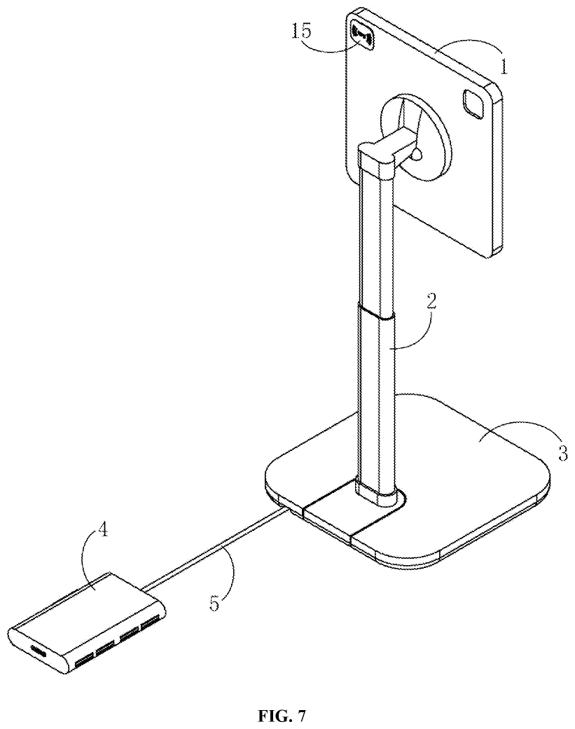

There are two limiting members 42. The two limiting members 42 cooperate with the limiting disk 413, so that a rotation angle of the tablet computer is within 90 degrees. Due to the cooperation between the turning assembly 40 and the stand 2, the rotation angle of the tablet computer can be within 270 degrees. As shown in FIG. 6, the damping member is a connection sleeve capable of increasing the friction force between the first frame bar 20 and the second frame bar 21. The connection sleeve is fixedly connected with the first frame bar 20, and the first frame bar 20 is connected with the second frame bar 21 through the connection sleeve.

The interface assembly 43 includes a 6PIN connector and a fixing plate used for fixing the 6PIN connector.

The fixing plate is arranged on the limiting disk 413. Through slots are formed in the magnetic attraction disk 414 and the rotating disk 411. The 6PIN connector is fixed inside the fixing plate. A spring needle of the 6PIN connector passes through the through slots and extends out of the magnetic attraction disk 414.

The rotating disk 411 is connected with the limiting disk 413 through a connection member.

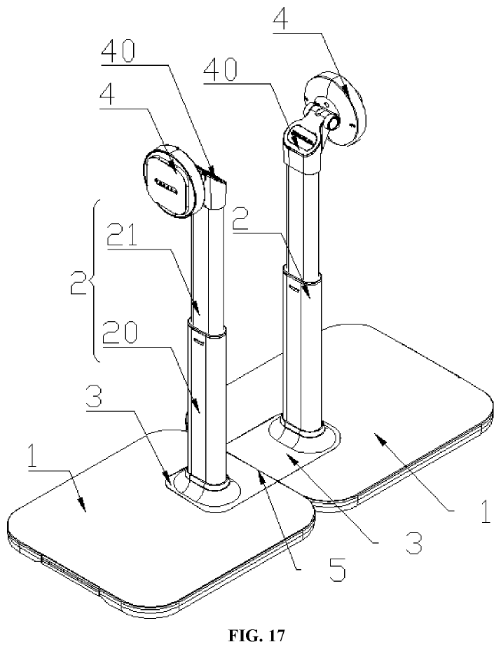

Referring to FIG. 17, this embodiment provides a charging stand for electronic equipment (such as a tablet computer). The base 1 is provided with a magnetic attraction member 5 along a side edge. A plurality of charging device main bodies are adjacently combined through the magnetic attraction members 5.

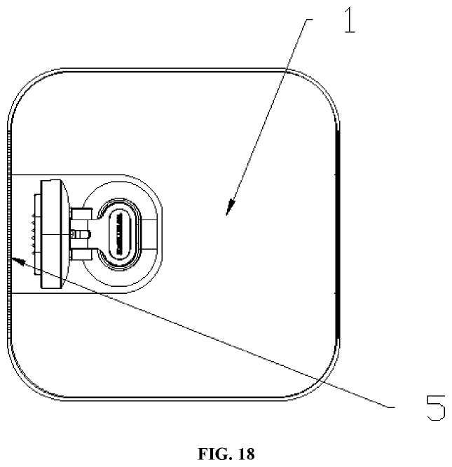

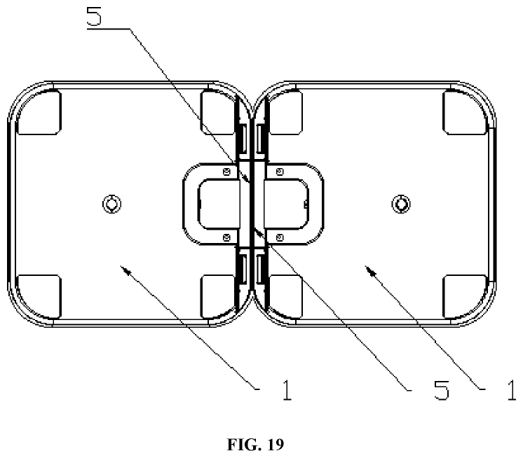

Referring to FIG. 18 and FIG. 19, a first assembly part 10 and a second assembly part 11 are respectively an upper shell body and a lower shell body. The upper shell body and the lower shell body are connected through cooperation between a bolt and a thread. The magnetic attraction member 5 is arranged on the upper shell body and/or the lower shell body. The plurality of charging device main bodies are adjacently combined through the magnetic attraction members 5. In a specific magnetic attraction operation, magnetic poles of the magnetic attraction members 5 of two charging device main bodies are opposite. That is, a positive electrode of the magnetic attraction member 5 of one charging device main body is outward, and a negative electrode magnetic attraction member 5 of the other charging device main body is outward, so that it ensures that the two magnetic attraction members 5 can attract each other, instead of repelling each other.

There may be two stands 2, two connection portions 3, and two rotating modules 4, so that the charging stand for electronic equipment in this embodiment may charge two tablet computers at the same time.

The tablet computers that are magnetically attracted will not collide with each other in any rotation angles, and a plurality of stands 2 can be fixed on the base 1 if the base 1 has an enough space.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A charging stand for electronic equipment, comprising a protection shell, an adjustable stand, and a base, wherein one end of the adjustable stand is detachably electrically connected to the protection shell, and the other end is connected to the base; a typer-c interface connected to a charging jack of electronic equipment is arranged in the protection shell; and the typer-c interface is connected to an internal circuit of the base through a circuit inside the adjustable stand.

2. The charging stand for electronic equipment according to claim 1, wherein a groove is formed in the protection shell; the adjustable stand comprises a bulge, a turntable, a connection buckle, a telescopic rod, and a connection seat; one end of the telescopic rod is fixedly connected to the connection seat, and the other end is fixedly connected to the connection buckle; the other end of the connection buckle is hinged with the turntable; the other surface of the turntable is connected with the bulge; and the bulge is clamped in the groove when the adjustable stand is connected with the protection shell.

3. The charging stand for electronic equipment according to claim 2, wherein the bulge and the groove are connected in a magnetic attraction manner; and the bulge and the turntable are rotatably connected.

4. The charging stand for electronic equipment according to claim 2, wherein a bottom of the groove is provided with a metal contact hole; the metal contact hole is electrically connected with the typer-c interface in the protection shell; a metal contact point matched with the metal contact hole is arranged on the bulge; the metal contact point is electrically connected to the circuit inside the adjustable stand; the metal contact point is inserted into the metal contact hole when the bulge is clamped in the groove; and the metal contact point and the metal contact hole are pogo pin connectors.

5. The charging stand for electronic equipment according to claim 2, wherein a mounting gap is formed in an edge of the base; the connection seat is mounted in the mounting gap; and the mounting gap and the connection seat are connected in a magnetic attraction manner.

6. The charging stand for electronic equipment according to claim 1, further comprising a docking station, wherein the docking station is connected to the internal circuit of the base through a lead wire to provide electric energy to the entire charging stand for electronic equipment; and a plurality of interfaces used for data transmission are further arranged on the docking station.

7. The charging stand for electronic equipment according to claim 1, further comprising a built-in NFC chip, a groove space is arranged inside the protection shell; the NFC chip is mounted in the groove space; the typer-c interface is further arranged in the protection shell; the typer-c interface is connected to the NFC chip through a circuit; one end of the adjustable stand is detachably connected to the protection shell, and the other end is connected to the base; and the typer-c interface is connected to an internal circuit of the base through a circuit inside the adjustable stand.

8. The charging stand for electronic equipment according to claim 7, wherein an NFC sign is arranged at a position, corresponding to the NFC chip, on the protection shell; and a camera opening is further arranged on the protection shell.

9. The charging stand for electronic equipment according to claim 7, further comprising a docking station; the docking station is connected to the internal circuit of the base through a lead wire; the docking station is connected to an external power supply to provide electric energy to the entire protection shell with the built-in NFC chip; and a plurality of interfaces used for data transmission are further arranged on the docking station.

10. The charging stand for electronic equipment according to claim 9, wherein a groove is arranged in the protection shell; the adjustable stand comprises a bulge, a turntable, a connection buckle, a telescopic rod, and a connection seat; one end of the telescopic rod is fixedly connected to the connection seat, and the other end is fixedly connected to the connection buckle; the other end of the connection buckle is hinged with the turntable; the other surface of the turntable is rotatably connected with the bulge; and the bulge is clamped in the groove when the adjustable stand is connected with the protection shell.

11. The charging stand for electronic equipment according to claim 10, wherein a bottom of the groove is provided with a metal contact hole; the metal contact hole is electrically connected with the typer-c interface in the protection shell; a metal contact point matched with the metal contact hole is arranged on the bulge; the metal contact point is electrically connected to the circuit inside the adjustable stand;
the metal contact point is inserted into the metal contact hole when the bulge is clamped in the groove; and the metal contact point and the metal contact hole are pogo pin connectors.

12. The charging stand for electronic equipment according to claim 11, wherein a mounting gap is formed in an edge of the base; the connection seat is mounted in the mounting gap; and the mounting gap and the connection seat are connected in a magnetic attraction manner.

13. A charging stand for electronic equipment, comprising a shell body used for fixing electronic equipment, wherein the shell body is detachably connected with a back splint; the back splint is connected with a telescopic rod; a bottom of the telescopic rod is fixed to a base; a positioning slot is formed in a side surface of the shell body facing the back splint; a metal plate is arranged in the positioning slot; a side edge of the shell body is provided with a Type-C interface connected to a charging jack of the electronic equipment; a lead wire for connecting the metal plate with the Type-C interface is arranged in the shell body; a side surface of the back splint facing the shell body is provided with a bulge portion matched with the positioning slot; a pogo pin metal ejection contact point and a first magnetic member are arranged on the bulge portion; the base is provided with a Type-C power line; the Type-C power line and the pogo pin metal ejection contact point are communicated through a lead wire; and the lead wire is arranged in the base, the telescopic rod and the back splint.

14. The charging stand for electronic equipment according to claim 13, wherein a side surface of the shell body facing the back splint is provided with an NFC module accommodating slot;
an avoiding hole used for avoiding a component of the electronic equipment is formed in the shell body in a manner of running through the shell body in a thickness direction;
the metal plate is arranged in a center of the positioning slot, and a second magnetic member magnetically attracting the first magnetic member is further arranged around a circumferential direction of the metal plate; a thickness of the second magnetic member is not less than that of the metal plate; and
one side of the base is provided with an external connection magnetic member used for magnetically attracting external equipment.

15. The charging stand for electronic equipment according to claim 14, wherein a bottom surface of the base is provided with a T-shaped avoiding slot; the T-shaped avoiding slot is communicated with three side edges of the base; and an elastic buckle used for buckling the Type-C power line is arranged in the T-shaped avoiding slot.

16. A charging stand for electronic equipment, comprising a charging device main body, wherein the charging device main body comprises a base, a rotating module, a stand, and a connection portion used for connecting the base with the stand; the rotating module is arranged on the stand;
a mounting region used for providing a mounting space for the connection portion is arranged on the base; the connection portion comprises a fixed member and a mounting socket arranged on the fixed member; a fastener is arranged on the fixed member; a fastening slot matched with the fastener is arranged on the base; the mounting socket is detachably connected with the stand; the fixed member is detachably connected into the mounting region;
a sliding alignment assembly is arranged between the mounting region and the fixed member; the sliding alignment assembly comprises a sliding chute and a sliding plate matched with the sliding chute; the sliding chute is formed inside the mounting region; and the sliding plate is arranged along a side edge of the fixed member.

17. The charging stand for electronic equipment according to claim 16, wherein the rotating module comprises a turning assembly, a rotating assembly, a limiting member arranged on the turning assembly, and an interface assembly arranged on the rotating assembly; the turning assembly is movably connected with the stand; and the rotating assembly is detachably connected with the turning assembly.

18. The charging stand for electronic equipment according to claim 16, wherein the stand comprises a first frame bar, a second frame bar, and a damping member; the first frame bar is connected with the second frame bar through a damping member; the mounting socket is detachably connected to the first frame bar; and the turning assembly is movably connected to the second frame bar;
the base comprises a first assembly part and a second assembly part; the first assembly part is provided with a wire duct along a side edge; and a wire outlet matched with the wire duct is further formed in the first assembly part.

19. The charging stand for electronic equipment according to claim 17, wherein the turning assembly comprises a mounting disk used for connecting the rotating assembly, a mounting table, a turning member, a rotating pin used for connecting the turning member, and a fixing table used for fixing the rotating pin; the mounting table is fixedly connected with the second frame bar; the fixing table is fixedly mounted on the mounting table; the turning member is movably connected to the fixing table through the rotating pin; the turning member is fixedly connected to the mounting disk; and the turning pin is used as a rotating shaft of the turning member to rotate the turning member after the turning member is stressed;
the rotating assembly comprises a rotating disk, a limiting disk, a magnetic attraction disk arranged on the rotating disk, and a spinning disk; the rotating disk is connected to the spinning disk; the spinning disk is movably connected to the turning assembly; the limiting disk is rotatably connected to the spinning disk; the spinning disk drives the limiting disk to rotate under the action of an axial force; the rotating disk rotates with the rotation of the spinning disk; the limiting member is matched with the limiting disk; the limiting member is used for limiting a rotation range of the limiting disk;
the interface assembly comprises a 6PIN connector and a fixing plate used for fixing the 6PIN connector; the fixing plate is arranged on the limiting disk; through slots are formed in the magnetic attraction disk and the rotating disk; the 6PIN connector is fixed inside the fixing plate;
and a spring needle of the 6PIN connector passes through the through slots and extends out of the magnetic attraction disk.

20. The charging stand for electronic equipment according to claim 16, wherein the base is provided with a magnetic attraction member along a side edge of the base; and a plurality of charging device main bodies are combined through the magnetic attraction members.
